(19) United States
(12) Patent Application Publication
(10) Pub. No.: US 2008/0301320 A1
(43) Pub. Date: Dec. 4, 2008

(54) Method And System For Managing Communication Protocol Data Based On MIME Types

(76) Inventor: Robert P. Morris, Raleign, NC (US)

Correspondence Address: SCENERA RESEARCH, LLC, 111 CORNING RD., SUITE 220, CARY, NC, 27518, US

(21) Appl. No.: 11/756,450

(22) Filed: May 31, 2007

(51) Int. Cl. G06F 15/173

(52) U.S. Cl. 709/238

(57) ABSTRACT

Methods and systems are described for managing communication protocol data in a communication stack of an electronic device. One method includes providing a MIME type communication layer in a communication stack that comprises a plurality of communication layers and is operatively coupled to a network interface for receiving and sending data over a network. The MIME type communication layer receives a protocol frame that includes content in a payload, and an endpoint identifier associated with a recipient of the content, determines a MIME type associated with the content, identifies an element by parsing the content of the protocol frame based on the determined MIME type, and determines a data item corresponding to the identified element of the determined MIME type. The data item is provided to the recipient asociated with the endpoint identifier. wherein the recipient receives the data item without parsing the content of the protocol frame.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

According to a common framework for network design, the complex task of host-to-host networking, an example of inter-networking, is divided into layers that are ordered from a lowest level to a highest level in a communication stack. For example, one known framework, referred to as a TCP/IP model or Internet reference model, is a layered abstract description for communications and computer network protocol design. One common version of this model includes five (5) communication layers, as follows:

Layer 5—Application Layer

Layer 4—Transport Layer

Layer 3—Network Layer

Layer 2—Data Link Layer

Layer 1—Physical Layer

Generally, layer 5 is referred to as a top layer and is logically closer to a user, while layers 1-4 are referred to as lower layers and are logically closer to the physical transmission of the data.

Another common model is the Open Systems Interconnection (OSI) model, which includes seven (7) communication layers. In this model, the Application Layer (layer 5) in the TCP/IP model is split into three layers: the application layer, a presentation layer and a session layer, which are referred to as the upper layers. The lower layers are similar to those in the TCP/IP model.

Generally, the top or upper layers, e.g., layer 5 in the TCP/IP model and layers 5-7 in the OSI model, refer to the programs that initiate network communications. TCP/IP includes several application layer protocols for mail, file transfer, remote access, authentication and name resolution. These protocols are embodied in programs that operate at the top/upper layers. Typically, application programmers deal with the top/upper layer protocols. In contrast to the top/upper layers, the lower layers, e.g., layers 1-4 in both the TCP/IP and OSI models, provide more primitive network-specific functions like routing, addressing, and flow control. Typically, layer 3 and layer 4 protocols are services provided by the communication stack in the operating system. Microcontroller firmware in a network adapter usually handles layer 2 issues, supported by driver software in the operational system.

According to both models, each communication layer plays a specific role in preparing data to be sent over or received from a network. Each layer is able to communicate with the layer immediately above it and/or the layer immediately below it. For example, data content to be sent over the network is created by an application in the application layer and passed down into a lower layer protocol of the transport layer. The role of the transport layer is to provide transparent transfer of data between end users, thus relieving the top/upper layers from any concern with providing reliable and cost-effective data transfer. The transport layer is typically responsible for end-to-end message transfer capabilities independent of the underlying network, including error recovery, data flow control, and ensuring complete data transfer. The transport layer packages the data into a packet. In some instances, the transport layer can repackage long messages into smaller packets for transmission. Packets are then passed down to the network layer.

The network layer is responsible for getting packets from a source to a destination, frequently traversing several networks. When the network layer receives a packet of data, it addresses the packet to the recipient. The network layer can translate logical addresses and names into physical addresses. The network layer can also determine the route from the source to the destination and manage network traffic. Once addressed, the packet is passed down to the data link layer, which formats the addressed packet into a network protocol frame. The frame is passed to the physical layer, which is responsible for encoding and sending the frame over network communications media. Ethernet, Token Ring, SCSI, hubs, repeaters, cables and connectors are standard network devices that function at the physical layer. Each layer can have its own packet or frame structure and can operate without knowledge of the packet or frame structure of the layers above and/or below it. In some embodiments, a layer can be implemented using knowledge of the packet structure of the layer above it and/or the layer below it.

On the receiving end, the frame is received at the physical layer and passed up to the data link layer, which extracts the addressed packet and passes it to the network layer. The network layer analyzes the recipient address and passes the packet to the transport layer, which extracts the data content from the packet and passes it to the recipient, e.g., an application, an operating system, or some other subsystem, via the application layer.

Each application that receives and sends data content over the network supports a communication protocol, such as HTTP or XMPP, and is configured to handle data of a certain type, e.g., a Multipurpose Internet Mail Extensions (or MIME) type, compatible with the protocol. When receiving data content, the application parses the content and validates the data to ensure that the data is properly formatted before the application uses the data. When sending data, the application formats the data according to its MIME type so that it can be sent using the supported protocol. Accordingly, each application includes programming code for parsing the content and for validating the data, as well as code for supporting the protocol and for formatting the data.

On any given communication device, several applications support the same communication protocol and/or handle the same typed MIME data. Accordingly, programming code for parsing, validating, and formatting data of well-known and frequently used MIME types is typically duplicated across several applications. In addition to this inefficiency in both resources and memory, the dependence on the applications to ensure data validity is a major source of vulnerability of devices to viruses, worms, and other malicious software. For example, because the applications typically control the communication endpoints, an application with weak data validity standards can allow malicious software to enter the device. In this manner, the security of any device or system is only as strong as the security provided by the weakest application that has access to a networking communication port. Moreover, because the device is typically coupled to an internal network, e.g., a LAN or a subnet, the “weak link” also exposes the internal network to malicious attacks.

Accordingly, there exists a need for methods, systems, and computer program products for managing communication protocol data received by and sent from applications in a device over a network.

### SUMMARY

Methods and systems are described for managing communication protocol data in a communication stack of an electronic device. One method includes providing a MIME type communication layer in a communication stack of an electronic device, where the communication stack comprises a plurality of communication layers and is operatively coupled to a network interface for receiving and sending data over a network. The method also includes receiving by the MIME type communication layer a protocol frame that includes content in a payload, and an endpoint identifier associated with a recipient of the content, determining by the MIME type communication layer a MIME type associated with the content, identifying by the MIME type communication layer an element of the determined MIME type by parsing the content of the protocol frame based on the determined MIME type, and determining by the MIME type communication layer a data item in the content corresponding to the identified element of the determined MIME type. The MIME type communication layer provides the data item to the recipient asociated with the endpoint identifier so that the recipient can receive the data item without parsing the content of the protocol frame

In another aspect of the subject matter disclosed herein, another method for managing communication protocol data in a communication stack of an electronic device includes providing a MIME type communication layer in a communication stack of an electronic device, where the communication stack comprises a plurality of communication layers and is operatively coupled to a network interface for receiving and sending data of a specified MIME type over a network. The MIME type communication layer receives a data item for association with an element of a specified MIME type, and a communication endpoint identifier associated with a sender of the data item, determines whether the data item is compatible with the element of the specified MIME type, and generates content including the data item that is compatible with the specified MIME type when the data item is determined to be compatible with the element of the specified MIME type. The content and the communication endpoint identifier are then provided to an underlying communication layer of the communication stack.

In another aspect of the subject matter disclosed herein, a system for managing communication protocol data in a communication stack of an electronic device includes means for receiving a protocol frame that includes content in a payload, and an endpoint identifier associated with a recipient of the content, means for determining by the MIME type communication layer a MIME type associated with the content, means for identifying an element of the determined MIME type by parsing the content of the protocol frame based on the determined MIME type, means for determining a data item in the content corresponding to the identifed element of the determined MIME type, and means for providing the data item to the recipient asociated with the endpoint identifier, wherein the recipient receives the data item without parsing the content of the protocol frame.

In another aspect of the subject matter disclosed herein, a system for managing communication protocol data received by and sent from an electronic device includes a network interface card configured for receiving and sending data over a network and a communication stack component coupled to the network interface card. The communication stack component includes a physical communication layer coupled to the network interface card and a MIME type communication layer configured for receiving via the physical communication layer a protocol frame that includes content in a payload, and an endpoint identifier associated with a recipient of the content. The MIME type communication layer includes a content router component configured for determining a MIME type associated with the content of the protocol frame, and a content controller component associated with the determined MIME type. When the content router determines the MIME type associated with the content of the protocol frame, the content router routes the content to the content controller component associated with the determined MIME type. The content controller component is configured for identifying an element of the determined MIME type by parsing the content of the protocol frame according to the determined MIME type, for determining a data item in the content corresponding to the identified element of the determined MIME type, and for providing the data item to the recipient asociated with the endpoint identifier, wherein the recipient receives the data item without parsing the content of the protocol frame.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for managing communication protocol data in a communication stack of an electronic device according to an exemplary embodiment;

FIG. 2 is a flowchart illustrating a method for managing communication protocol data in a communication stack of an electronic device according to an exemplary embodiment;

FIG. 3A is a block diagram illustrating an exemplary content controller component according to an exemplary embodiment;

FIG. 3B is a block diagram illustrating an exemplary application/xmpp+xml content controller component according to an exemplary embodiment; and

FIG. 4 is a flowchart illustrating a method for managing communication protocol data in a communication stack of an electronic device according to another exemplary embodiment.

### DETAILED DESCRIPTION

Methods, systems, and computer program products for managing communication protocol data in a communication stack of an electronic device are disclosed. According to one embodiment, data received by the electronic device via a network, such as the Internet, is received and processed by a MIME type communication layer in a communication stack and passed to a designated application so that the application can receive the data pre-processed and ready for use. In addition, the MIME type communication layer can process data to be sent from the application so that the application needs only to provide the raw data item to the MIME type communication layer, which prepares the raw data for transmission over the network. As suggested by its name, the MIME type communication layer can process the incoming or outgoing data according to the data's MIME type. In one embodiment, the MIME type communication layer can parse, validate and format the data based on the data's MIME type.

By providing the MIME type communication layer in the communication stack, common data processing functions, e.g., parsing, validation, and formatting, can be transferred from the applications to a common provider. This consolidation reduces program code duplication amongst the applications in the device. Moreover, because the MIME type communication layer is controlled by the trusted operating system, strong security policies can be enforced uniformly and application developers can be relieved of the responsibility of providing security through the applications.

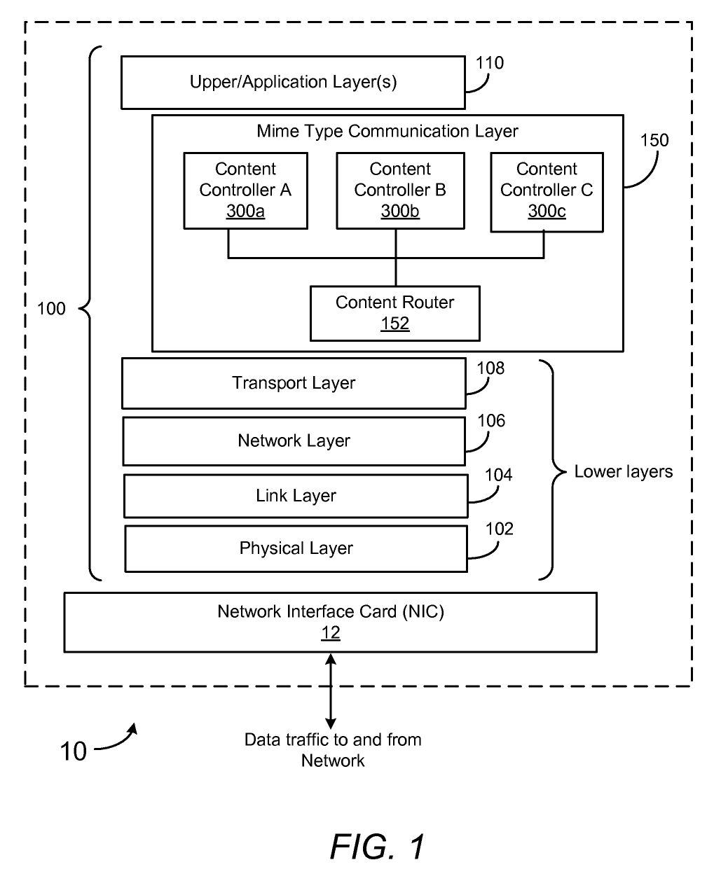

FIG. 1 is a block diagram illustrating an exemplary system for managing communication protocol data in a communication stack of an electronic device according to an exemplary embodiment. The system 10 can be included in an electronic device that is configured to send and receive data over a network, such as a LAN or Internet. The system 10 includes a network interface card (NIC) 12 and a communication stack 100. The electronic device in which the system 10 can be included provides a supporting operating environment that includes, for example, a processor, various hardware subsystems supporting data input and output, an operating system or control program, applications, and software subsystems including a communication subsystem providing the communication stack 100, and drivers enabling communication with the various hardware subsystems by the software subsystems, operating system, and applications. Exemplary electronic devices include, without limitation, a personal computer, a server, a network switch, and a mobile computing device. These devices and their components are well-known including the design and operation of networking stacks included in these devices. Thus, a detailed description of the devices, supporting hardware, and operating environments is not provided.

The communication stack 100 is communicatively coupled to the NIC (12) and includes a plurality of lower communication layers 102-108 and at least one upper/application layer 110. In one embodiment, the plurality of lower communication layers includes a physical layer 102, a data link layer 104, a network layer 106, and a transport layer 108. The functionality and characteristics of these communication layers are substantially similar to those functions and characteristics of those described above with regard to the TCP/IP model and OSI model. For example, the physical layer 102 can be embodied by an NIC supporting an Ethernet physical communication layer, such as Ethernet signals over a Cat 5e cable. As previously described, above the physical layer 102, the data link layer 104 can be an Ethernet link communication layer, and above the link layer 104, the network layer 106 can be an IP network communication layer. Above the network layer 106, the transport layer 108 can be a connection oriented transport communication layer supporting TCP, and/or a datagram oriented transport communication layer supporting UDP, both supported by the IP network communication layer below.

Communication endpoints are supported by the transport layer 108 and a communication API (not shown) provides an interface between the endpoints and the transport layer 108. For example, sockets is a well-known communication API providing access to TCP and UDP as well as supporting access to other communication protocols. Through the sockets communication API, communication endpoints can be identified by port identifiers. TCP ports are allocated and assigned port numbers identifying connection oriented communication endpoints, while UDP ports are allocated and assigned port numbers identifying datagram communication endpoints.

According to one exemplary embodiment, the communication stack 100 includes a MIME type communication layer 150 situated between the upper/application layers 110 and the physical layer 102, and configured for processing incoming and outgoing data according to the data's MIME type. In one embodiment, the MIME type communication layer 150 includes a plurality of content controller components 300a, 300b, 300c. Each content controller component 300a, 300b, 300c is configured to process data of a specific MIME type or MIME type family, from the wide variety of defined MIME types, and MIME types yet to be defined. For example, the MIME type communication layer 150 can include a “text/html” content controller 300a for processing HTML type content, an “application/xmpp+xml” content controller 300b for processing XMPP type, and an “image/*” content controller 300c for processing content of a variety of digital image types.

In one embodiment, the MIME type communication layer 150 includes a content router component 152 that can support a plug-in interface for adding one or more content controller components 300a-300c. The plug-in interface (not shown) can allow the MIME type communication layer 150 to support any content having a MIME type corresponding to a compatible content controller component 300a that is registered and/or configured to be operatively coupled to the content router component 152 via the plug-in interface. In one embodiment, the content controller component 300a can be registered via a configuration file, e.g., written in XML. The configuration file can include MIME information indicating one or more MIME types with which the content controller component 300a is compatible, and access information that allows the content controller component 300a to be located and loaded, if necessary, for use by the MIME type communication layer 150.

Alternately or in addition to providing configuration support for adding a content controller component 300a, the MIME type communication layer 150 can include a programming interface for registering the content controller component 300a. Registration invocation parameters can pass information analogous to the information in the configuration file described above. One skilled in the art can use a variety of existing mechanisms for providing component registration and configuration that will allow the MIME type communication layer 150 to be configured to support new content controller components 300a-300c in light of the description provided herein.

Typically, each lower communication layer 102-108 is associated with a corresponding protocol frame format defining a protocol header and/or a protocol trailer for the layer. For example, data received via the NIC 12 at the first communication layer, e.g., the physical layer 102, is received as a protocol frame of the second communication layer, e.g., the data link layer 104, in the communication stack 100 above the first communication layer 102. The second communication layer 104 strips off the header and/or trailer associated with the second communication layer 104 and passes the payload of the second communication layer protocol frame to a third communication layer, e.g. the network layer 106.

The payload of the second communication layer is received as a protocol frame of the third communication layer 106. In one embodiment, for example, the third communication layer is the network layer 106 and the protocol frame can include an IP header and/or trailer indicating that the network layer 106 is an IP communication layer. The network layer 106 processes and strips off the header and/or trailer of its corresponding protocol frame, and passes the payload to a fourth communication layer, typically the transport layer 108. The transport layer 108 processes and strips off the header and/or trailer of its corresponding protocol frame, and passes the payload to the next communication layer above it.

In one embodiment, the payload of the transport layer 108 is received as a protocol frame of the MIME type communication layer 150, which can include a MIME type layer header and/or trailer and a payload. The MIME type communication layer 150 can strip off the header and/or trailer of its corresponding protocol frame and use one of the content controller components 300a-300c to process data content in the payload according to the data's MIME type. According to one exemplary embodiment, the MIME type communication layer 150 can deliver the processed data content as a payload to an identified communication endpoint associated with a recipient, such as an application, an operating system, or some other subsystem of the electronic device.

While the communication stack 100 described above can support TCP/IP networking protocols and includes at least five communication layers, other communication stacks supporting other communication protocols can be implemented using only two or more communication layers including the physical communication layer 102. All such communication stacks are considered to be within the scope of the systems, methods, and program products described in this document. Moreover, while the MIME type communication layer 150 can operate above the transport layer 108 in one exemplary embodiment, it can also operate at any layer of the communication stack 100 above the physical layer 102 in other embodiments. Thus, FIG. 1 depicts but one configuration of the exemplary embodiment, and other configurations can be implemented.

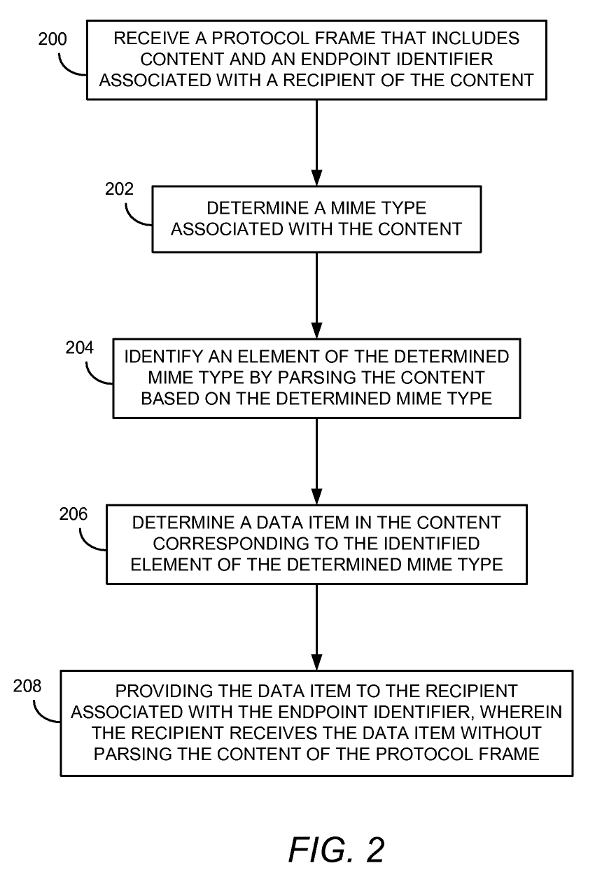

FIG. 2 is a flowchart illustrating a method for managing communication protocol data in a communication stack 100 of an electronic device according to an exemplary embodiment. Referring to FIG. 1 and FIG. 2, the exemplary process begins when the MIME type communication layer 150 receives a protocol frame that includes content in a payload and a communication endpoint identifier associated with a recipient of the content (block 200). The MIME type communication layer 150 defines its own protocol frame format that can include headers and or trailers. In one embodiment, the MIME type communication layer 150 processes the header and/or trailer and locates data included in the payload of the MIME type communication layer protocol frame received. Included in the payload and/or the MIME type protocol frame is content of a determinable MIME type and the communication endpoint identifier associated with the recipient of the content, such as an application or a next communication layer above the MIME type communication layer 150.

According to an exemplary embodiment, the MIME type communication layer 150 includes means for receiving the protocol frame that includes the content and the communication endpoint identifier associated with the recipient of the content. For example, the MIME type communication layer 150 can include a content router component 152 configured to receive the protocol frame. In one embodiment, the content router component 152 can receive the protocol frame of the MIME type communication layer from a lower communication layer, such as the transport layer 108, via the sockets communication API. The communication endpoint identifier included in the protocol frame can be a TCP port number or a UDP port number. Alternately, an embodiment of a MIME type communication layer 150 can provide its own communication endpoint identifier and therefore hide the transport layer communication endpoint identifier, e.g., the port number identifying the port, from the recipient.

After the MIME type communication layer 150 receives the protocol frame, the MIME type communication layer 150 determines a MIME type associated with the content (block 202). According to an exemplary embodiment, the MIME type communication layer 150 includes means for determining the MIME type associated with the content. For example, the content router component 152 can be configured to perform this function in one exemplary embodiment.

For example, the MIME type communication layer's protocol frame format can include a MIME type indicator in at least one of the MIME type protocol frame header, trailer, and payload. Thus, when the content router component 152 processes the header and/or trailer of the protocol frame, it can determine the MIME type associated with the content based on the MIME type indicator in the header and/or trailer.

In another embodiment, the determined MIME type can be a multipart type when the payload of the MIME type protocol frame includes multiple content portions of varying MIME types. For example, the payload of the MIME type protocol frame can include a first content portion and a first MIME type indicator that identifies a first MIME type associated with the first content portion of the payload, along with a second content portion and a second MIME type indicator that identifies a second MIME type associated with the second content portion of the payload.

In yet another embodiment, the MIME type protocol frame format does not provide a MIME type indicator in the header, the trailer, or the payload. In this embodiment, the content router component 152 determines the MIME type associated with the content portion of the payload by analyzing the content. For example, the MIME type can be determined by identifying a signature or other characteristic included in the content itself.

In one exemplary embodiment, the content router component 152 can use a content controller component 300a-300c to determine the MIME type of the content. For example, the content router component 152 can use a content controller component, e.g., 300a, to test a portion of the content to determine its MIME type. The content controller component 300a can analyze the portion of the content to determine whether the content includes a signature, a type indicator and/or some other characteristic indicative of the MIME type.

If the portion of the content is of a MIME type compatible with the content controller component 300a, an indication can be returned to the content router component 152 so that the content router component 152 can determine that the MIME type associated with the content is that associated with the compatible content controller component 300a. Otherwise, when the portion of the content is not compatible with the content controller component 300a, the content router component 152 can invoke another content controller component 300b to test the content.

When the MIME type associated with the content has been determined, the MIME type communication layer 150 identifies an element of the determined MIME type by parsing the content of the protocol frame based on the determined MIME type (block 204). In an exemplary embodiment, a content controller component 300a compatible with the determined MIME type includes means for identifying an element of the determined MIME type by parsing the content based on the determined MIME type.

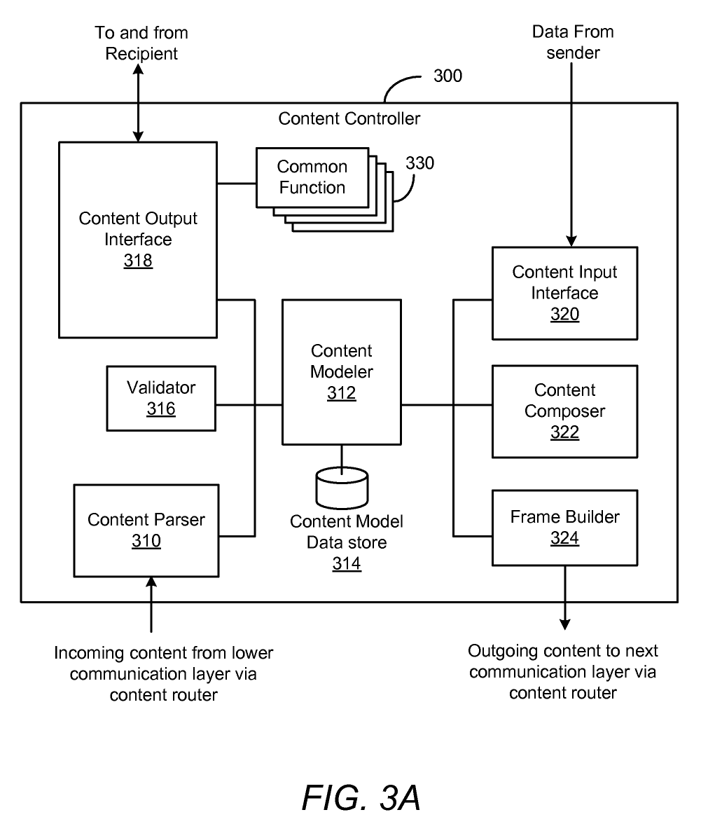

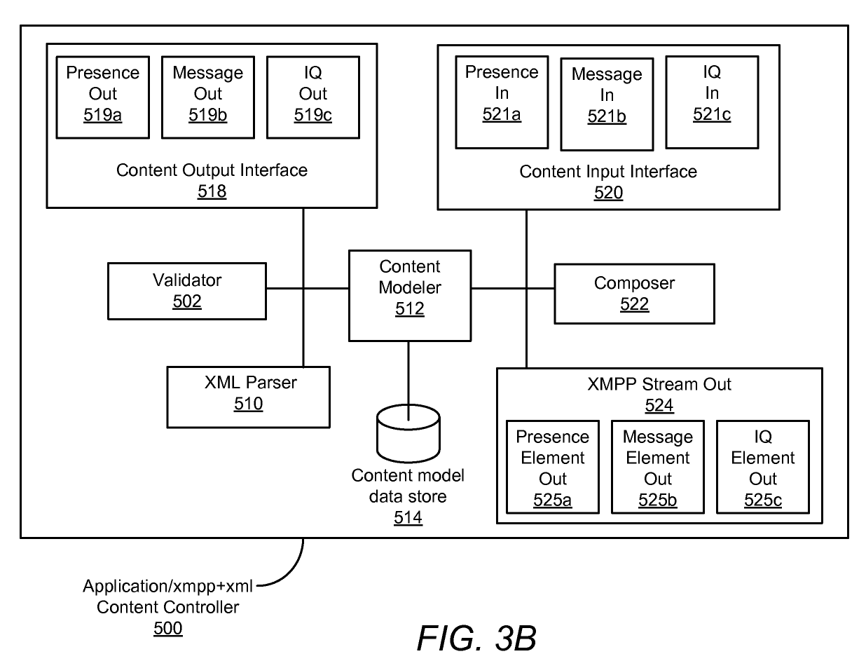

FIG. 3A and FIG. 3B are block diagrams illustrating an exemplary generic content controller component 300 and an exemplary content controller component 500 of a specific MIME type, respectively, according to one embodiment. Referring to FIG. 3A, the content controller component 300 can include, in one embodiment, a content parser component 310 that is compatible with the determined MIME type and configured to parse the content of the protocol frame according to a format associated with the determined MIME type of the content. In one exemplary embodiment, when the content router component 152 determines the MIME type of the content, it locates the content controller component 300 compatible with the determined MIME type.

The compatible content controller component 300 can be located, for example, by performing a lookup in a table that includes records associating a MIME type with a content controller component 300. For example, a MIME type identifier can be associated with a content controller identifier in the lookup table. In one embodiment, the content controller identifier can be a reference to an interface for invoking the content controller component 300. In another embodiment, the content controller identifier can be a pointer to an executable object embodying the compatible content controller component 300. In yet another embodiment, the content controller identifier can be a direct reference to an interface of the content parser component 310.

In one embodiment, if the content router component 152 cannot locate a compatible content controller component 300, it can return an error, and/or it can pass the unparsed content to the next layer of the communication stack 100 or to an application depending on the position of the MIME type communication layer 150 in the communication stack 100. If the content router component 152 can locate the compatible content controller component 300, the content router component 152 can pass the content to the content parser component 310 in the compatible content controller component 300.

In an exemplary embodiment, the content parser component 310 compatible with the determined MIME type can receive and parse the content according to a format associated with the determined MIME type. In one embodiment, the content parser component 310 can receive and dynamically parse the content as a stream of data or can receive and parse the content as a whole.

For example, referring to FIG. 3B, the content controller component 500 is compatible with content of the MIME type “application/xmpp+xml.” The “application/xmpp+xml” MIME type is used for supporting a presence protocol and an instant message protocol using the XMPP protocol. The content controller component 500 includes an XML parser 510 that is compatible with the “application/xmpp+xml” MIME type, and that receives XMPP data from the content router component 152. In one embodiment, the XML parser 510 can be a Simple API for XML (or SAX) parser that dynamically parses the stream of XML data. Alternatively, the content parser component 310 can be a document object model (DOM) parser that receives and parses the content as a whole.

Referring again to FIG. 2, when the element of the determined MIME type is identified, the MIME type communication layer 150 determines a data item in the content corresponding to the identified element (block 206). In one embodiment, the MIME type communication layer 150 includes means for determining the data item corresponding to the identified element. For example, the content parser component 310 compatible with the determined MIME type can perform this function.

According to one embodiment, each identified element of the determined MIME type either is a data item itself or includes a data item. For example, a “<status>” element of an XMPP MIME type, e.g., application/xmpp+xml, includes a status value associated with a presentity of a presence system.

In one embodiment, the detected elements and the corresponding data items are passed to a content modeler component 312 in the content controller component 300. The content modeler component 312, in one embodiment, is configured to use a known format of the determined MIME type to construct a structured data model of the parsed content and to store the structured data model in a content model data store 314. By storing the structured data model of the parsed content, access to the parsed elements and corresponding data items of the content can be provided without reparsing the content.

In an exemplary embodiment, before, during or after the structured data model is constructed, the content parser component 310 or the content modeler component 312 can validate the detected elements and corresponding data items according to the determined MIME type using a validator component 316. In one embodiment, the validator component 316 can use a schema specification that defines the format of the determined MIME type. In some embodiments, multiple schemas are used. For example, the validator component 516 of the “application/xmpp+xml” content controller component 500 can use a schema defining an IM protocol of XMPP and a schema defining a presence protocol of XMPP, instead of a combined schema specification, to validate the detected elements and corresponding data items.

In one embodiment, the schema specification can be used by the validator component 316 to provide protection against malicious code or data in the content that can be a threat to the electronic device. Moreover, the validator component 316 can determine whether the recipient associated with the communication endpoint identifier is authorized to receive the data items. The validator component 316 can be configured to perform other types of checks, including but not limited to, privacy and security checks. Alternately, one or more plug-in components providing protection against malicious code and/or data, or performing other types of checks can be configured to provide these services in addition to any validation done by the validator component 316. The plug-ins can include knowledge of a specific MIME type to perform validation operations. Current anti-spyware and anti-virus tools are general purpose tools that are not MIME-type-specific.

Referring again to FIG. 2, once the data item corresponding to the identified element is determined, the MIME type communication layer 150 provides the data item to the recipient associated with the communication endpoint identifier such that the recipient receives the data item and/or is allowed to manipulate the data item without parsing the content of the protocol frame (block 208). In one embodiment, the MIME type communication layer 150 includes means for providing the data item to the recipient associated with the communication endpoint identifier. For example, the content controller component 300 compatible with the determined MIME type can include a content output interface 318 to perform this function.

According to an exemplary embodiment, the content output interface 318 can receive the determined data item directly from the content parser component 310 and immediately deliver the data item to the recipient associated with the communication endpoint identifier. In another exemplary embodiment, the content output interface 318 can provide an indication to the recipient associated with the communication endpoint identifier when content for the recipient is received and processed by the content controller component 300. In one embodiment, port numbers of TCP ports and UDP ports can be used as communication endpoint identifiers. A recipient, e.g., an application, can listen on a port or can open a connection to a port using the sockets communication API provided by the MIME type communication layer 150. Alternatively or additionally, the recipient can interact with the sockets communication API directly using a socket ID to identify a communication endpoint to the MIME type communication layer 150.

In one embodiment, the content output interface 318 can provide a callback interface for calling an executable routine associated with the communication endpoint identifier and for receiving a callback from the executable routine to retrieve the data item. In another embodiment, the content output interface 318 can provide a polling interface that allows the content output interface 318 to receive a query from an executable routine associated with the communications endpoint identifier and to send the indication to the recipient in response to the query.

In another embodiment, the content output interface 318 can provide an event driven interface such as a notification driven interface, where the content output interface 318 can send a notification including the indication to the recipient based on a subscription to the communication endpoint identifier. In yet another embodiment, the content output interface 318 can provide an interface that uses message queues, where the indication is placed in a message queue associated with the communication endpoint identifier.

According to an exemplary embodiment, the indication can include an identifier associated with the content and/or an identifier associated with one or more data items of the content. The recipient can use the received identifier(s) to retrieve the data item and/or other data items included in the content, or to allow access to the data item or data items by other executables using the received identifier(s). For example, the recipient can call the output content interface 318 passing the content identifier and an identifier of a portion of the content. In the case of an XML MIME type, the identifier can be an XPath expression for retrieving a particular XML element and/or its content. In another embodiment, XQuery and XPath can be used to query the content for all elements that have a particular attribute with a particular value.

For a media MIME type such as image, an identifier for a specific metadata field, e.g., the image type or image size, can be provided to the corresponding content output interface 318 of a compatible content controller component 300. In an alternate embodiment, a recipient can provide subscription information to the content output interface 318 subscribing to all data items in the content or subscribing to a portion of the data items. For example, a recipient of a presence message can subscribe to receive only the value of status elements received in presence content.

In one embodiment, when the content output interface 318 has sent the indication to the recipient and has received a response from the recipient to retrieve one or more data item(s) in the content, the content output interface 318 can retrieve the requested data item from the model data store 314 via the content modeler component 312, and pass the requested data item to the recipient. Alternatively, or in addition, the content output interface 318 can return an object representing the content to the recipient. In an object oriented environment this can be an instance of the structured data model created by the content modeler component 312 and stored in the content model data store 314. In a non-object oriented environment, the content can be provided in one or more data structures defined by the content output interface 318 of the content controller component 300 based on the determined MIME type.

In another embodiment, in addition to or instead of retrieving the data item of the content, the recipient can have the content controller component 300 apply one or more common functions against the data item. In this embodiment, the content controller component 300 can provide a plug-in interface for a set of common function modules 330 that provide common functions for use by the recipient of the content. For example, the set of common function modules 330 can include a display function, a storage function, an edit function and/or a delete function, as well as other common functions. When the content controller component 300 receives an instruction from the recipient to apply at least one common function against the data item, the content output interface 318 can invoke the appropriate common function module(s) 330 and apply it against the data item pursuant to the instruction.

For example, a recipient that receives HTML merely for the purpose of presentation can receive an indication that content has been received by the HTML compatible content controller component 300, and can instruct the content controller component 300 to display the data item. When the HTML compatible content controller 300 receives the instruction to apply the display function module against the data item, it invokes the display function module 330, which presents the content. In one embodiment, this function can be automated by the recipient requesting the automated display of HTML content. In this manner, the recipient is not required to process the received content as it is can be handled automatically by the content controller component 300. In another example, the storage function module 330 can provide a data base for storing all content compatible with the content controller component 300. Because a structured data store based on the MIME type is provided by the content controller component 300, the recipient is not required to provide its own data store to store the received data items. For example, a data store plug-in for storing data with still image, video, and/or audio MIME types in a data store can be provided for storing any received media items and associated metadata. The media and associated metadata can then be accessed by one or more applications via an interface provided by the data store and/or the data store plug-in. The data store can be configured to provide storage for albums, slideshows, playlists, etc. freeing each application using such media from having to provide function provided by the shared data store.

According to one exemplary embodiment, the content output interface 318 can provide one or more interfaces for each of the protocols supported by the content controller component 300. For example, referring to FIG. 3B, the content output interface 518 of the application/xmpp+xml content controller 500 provides interfaces for each of the protocols supported by the application/xmpp+xml MIME type. A recipient can receive presence protocol data items via a presence out component 519a, instant message protocol data items via a message out component 519b, and/or IQ request/response protocol data items via an IQ out component 519c.

According to aspects of the described embodiments, the recipient is not required to parse the content of the protocol frame or to be aware of the format of the data's MIME type. The recipient is not required to receive and/or handle all of the content. Rather, the recipient can choose to receive portions that are of particular interest to the recipient. In some embodiments, the recipient is not required to validate the content. In all embodiments, the recipient is not required to process any of the message or elements directly.

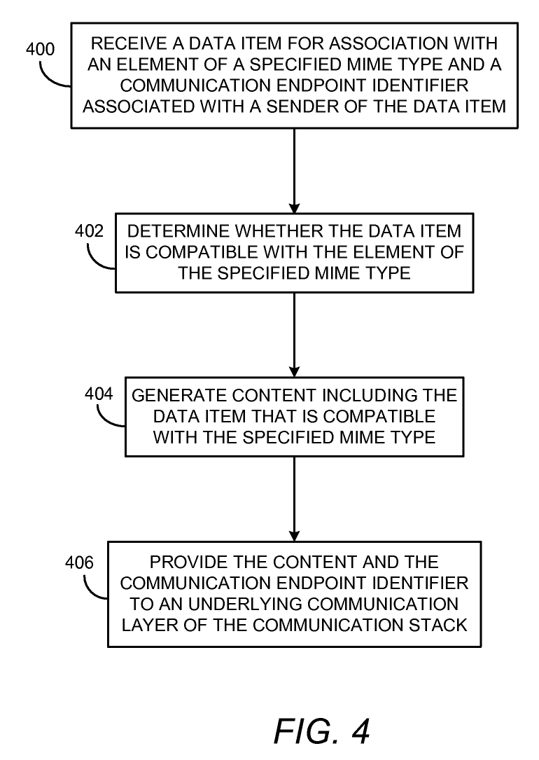

In another aspect of the subject matter disclosed herein, FIG. 4 is a flowchart illustrating a method for managing communication protocol data in a communication stack of an electronic device according to another exemplary. In this aspect, data that is to be sent over the network is processed by the MIME type communication layer 150 based on the data's MIME type.

Referring to FIG. 1, FIG. 3A, FIG. 3B and FIG. 4, the method begins when the MIME type communication layer 150 receives a data item to be associated with an element of a specified MIME type and a communication endpoint identifier associated with a sender of the data item (block 400). The data item, the communication endpoint identifier and optionally a MIME type identifier can be provided from an upper layer or from an application in the application layer 110 to the MIME type communication layer 150. In one embodiment, the data item can be at least a portion of the content of a message to be sent using the communication stack 100 that includes the MIME type communication layer 150. The communication endpoint identifier can be a port number of a socket opened or accepted by the sender.

In one embodiment, the MIME type communication layer 150 includes a content controller component 300 compatible with the specified MIME type, which includes a content input interface 320 for receiving the data item and the communication endpoint identifier associated with a sender of the data item. The content input interface 220 can be implemented in several ways. For example, referring to FIG. 3B, the application/xmpp+xml content controller 500 provides a “presence in” component 521a for transmitting presence data, a “message in” component 521b for transmitting instant message data, and a request/reply “IQ in” component 521c for transmitting request/reply messages. In some embodiments, the interfaces 521a-521c can be object oriented providing instances of presence messages, instant messages, and request/reply messages, while in other embodiments, the interfaces 521a-521c can be procedural and provide analogous function. Alternatively, or in addition, the interfaces 521a-521c can be asynchronous and/or synchronous in their operation.

Referring again to FIG. 4, once the data item and communication endpoint identifier are received, the MIME type communication layer 150 determines whether the data item is compatible with the element of the specified MIME type (block 402). In one embodiment, the content controller component 300 compatible with the specified MIME type includes a content composer component 322 for determining whether the data item is compatible with the element of the specified MIME type.

The content input interface 320, in one embodiment, can pass the received data item to the content composer 322, which can use the content modeler component 312 to construct content including the data item according to the specified MIME type. Prior to starting the content construction process, the content modeler component 312 can determine whether the data item is compatible with the element of the specified MIME type. To make this determination, the content modeler component 312 can invoke the validator component 316, which uses a schema that defines a format specification corresponding to the specified MIME type to validate the data item.

For example, referring to FIG. 3B, a sender included in the upper/application layers 110 can interoperate with the “presence in” component 521a of the content input interface 520 of the application/xmpp+xml content controller component 500. In one interoperation, the sender can indicate that an instance of a publish message is to be built. The “presence in” component 521a can then indicate to the content composer 522 that a publish message is to be built and transmitted. The content composer 522 can invoke the content modeler component 512 and provide an identifier of the schema defining the format for the publish message.

Thereafter or concurrently, the sender can provide data items, such as a tuple identifier, a status, and/or contact information, to the content composer 522 via the “presence in” component 521a for association with elements of the specified MIME type. The content composer component 522 can tell the content modeler component 512 to add each data item to the publish message being constructed. The content modeler component 512 uses the provided schema identifier to retrieve the schema defining the format for the publish message and uses the retrieved schema and the validator component 516 to ensure that the data items are compatible with the retrieved schema. If a data item is not compatible, an error indication generated by the validator component 516 can be passed to the sender identified by the communication endpoint. For example, the error indication can be sent via a callback interface, as an asynchronous message, or returned synchronously to the sender via the composer 522 and the content input interface 520.

Content controller components 300 for other MIME types can operate analogously. For example, an image/* content controller component 300c, in one embodiment, can use a format specification of an EXIF file for determining whether received data items are compatible according to the image/jpeg MIME type. A video content controller component, e.g., 300b, can use a video format specification, such as MPEG-4, for validating data items received in constructing content of the MIME type video/mpeg. Analogously, an audio content controller component can use an audio format specification, such as mp3, for validating data items received in constructing content of the MIME type audio/mp3.

In one embodiment, the content controller component 300 can transmit as well as receive content as a stream of data, e.g., video and audio content. In this embodiment, the content composer component 322 and content modeler component 312 can validate the data items as they are received. Validating streamed content can require that data items be received in an order compatible with real-time transmission. Text data types, on the other hand, may not require transmission in a streamed fashion. Thus, the content composer component 322 and the content modeler component 312 can be configured to accepted data items in any order.

A data item can be validated at the time it is received or at a later time after a set of data items have been received. For example, in one embodiment, a SAX parser component can be used for transmitting streamed XML data and validation can be performed while streaming. In another embodiment, a DOM parser can be used to construct an entire presence message, instance message, and/or request/reply message, and validation can be performed at any time prior to transmitting the message. In addition, during the validation process, security checks can be performed to ensure that the sender is allowed to the send the data item.

Referring again to FIG. 4, when the data item is determined to be compatible, the content modeler component 312 generates content including the data item, where the content is compatible with the specified MIME type (block 404). In one embodiment, the content composer 322 can use the content modeler component 312 to construct a structured data model representing the content using the schema that defines a format specification corresponding to the specified MIME type. In one embodiment, the content can be generated as data items are received, if provided in an appropriate order. In another embodiment, the content can be generated once all data items associated with the content have been received according to the specified MIME type of the content.

Once the content including the data item is generated, the content and the communication endpoint identifier associated with the sender is provided to an underlying communication layer of the communication stack 100 (block 406). In one embodiment, the content controller component 300 compatible with the specified MIME type includes a frame builder component 324 that receives the content from the content composer 322 and provides the content and the communication endpoint identifier associated with the sender to the underlying communication layer of the communication stack 100.

According to an exemplary embodiment, the frame builder component 324 can create a protocol frame compatible with a frame format associated with the MIME type communication layer 150 and include the content and the communication endpoint identifier associated with the sender in the protocol frame. In one embodiment, the protocol frame can also include a MIME type indicator associated with the specified MIME type. The frame builder component 324 can use the content router 152, in an embodiment, to determine when content can be included in a current protocol frame being built and/or partially transmitted, and when a new frame should be created.

In an embodiment, the protocol frame format of the MIME type communication layer 150 can require a header and/or a trailer. In this case, the content router 152 can build the header and/or trailer for sending a new frame or for indicating the end of the current frame, respectively, according to the frame format used.

In another embodiment, the protocol frame format of the MIME type communication layer 150 does not require headers and/or trailers. In this embodiment, an enhanced sockets API (not shown) above the MIME type communication layer 150 can be used and data can be sent as TCP data or as UDP data based on the requirements of a sending application. The sending application can provide data items to the enhanced sockets API, and receive data items included in the received content via the enhanced sockets API without having to know the format of the MIME type of the data sent and/or received. In one embodiment, the enhanced sockets API can hide ports numbers from API users and can also allow users of the enhanced sockets API to share a TCP and/or UDP port.

Through aspects of the embodiments described, a MIME type communication layer 150 in a communication stack 100 processes data received by and data sent from an electronic device based on the data's MIME type. Because such processing is handled by the MIME type communication layer 150, applications in the electronic device can be network/transport protocol independent and the applications can be written to a standard communication API. It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for managing communication protocol data in a communication stack of an electronic device, the method comprising:
providing a MIME type communication layer in a communication stack of an electronic device, wherein the communication stack comprises a plurality of communication layers and is operatively coupled to a network interface for receiving and sending data over a network;
receiving by the MIME type communication layer a protocol frame that includes content in a payload, and an endpoint identifier associated with a recipient of the content;
determining by the MIME type communication layer a MIME type associated with the content;
identifying by the MIME type communication layer an element of the determined MIME type by parsing the content of the protocol frame based on the determined MIME type;
determining by the MIME type communication layer a data item in the content corresponding to the identified element of the determined MIME type; and
providing by the MIME type communication layer the data item to the recipient asociated with the endpoint identifier, wherein the recipient receives the data item without parsing the content of the protocol frame.

2. The method of claim 1 wherein providing the MIME type communication layer includes dynamically registering with the MIME type communication layer at least one content controller associated with at least one MIME type and configuring the MIME type communication layer to invoke the at least one content controller.

3. The method of claim 1 wherein determining the MIME type associated with the content includes at least one of analyzing a MIME type indicator included in the received protocol frame, and analyzing at least a portion of the content to determine at least one of a signature, a type indicator, and a characteristic associated with the MIME type.

4. The method of claim 1 wherein identifying the element of the determined MIME type by parsing the content of the protocol frame based on the determined MIME type includes invoking a parser component compatible with the determined MIME type, and using the parser to parse the content according to a format associated with the determined MIME type.

5. The method of claim 1 wherein identifying the element of the determined MIME type by parsing includes:
identifying a plurality of elements in the content based on a format of the determined MIME type, wherein the plurality of identified elements are associated with a plurality of data items;
constructing a structured data model of the parsed content using the plurality of identified elements; and
validating the plurality of data items according to the format of the determined MIME type.

6. The method of claim 5 wherein identifying the element of the determined MIME type by parsing includes one of receiving a stream of data corresponding to the content to be parsed and dynamically parsing the stream of data, and receiving the content as a whole and parsing the content as a whole.

7. The method of claim 5 including storing the structured data model.

8. The method of claim 1 wherein providing the data item to the recipient includes sending an indication to the recipient, wherein the indication includes an identifier associated with at least one of the content and the data item.

9. The method of claim 8 wherein providing the data item to the recipient includes at least one of:
calling an executable routine associated with the endpoint identifier and receiving a callback from the executable routine to retrieve the data item;
receiving a query from an executable routine associated with the endpoint identifier and sending the indication to the recipient in response to the query;
sending a notification including the indication to the recipient based on a subscription to the endpoint identifier; and
placing the indication in a message queue associated with the endpoint identifier.

10. The method of claim 1 wherein providing the data item to the recipient includes:
providing by the MIME type communication layer a set of common functions associated with a MIME type, wherein the set of common functions includes at least one of a display function, a storage function, an edit function, and a delete function;
receiving from the recipient an instruction to apply at least one common function of the set against the data item of the MIME type; and
applying the at least one common function against the data item pursuant to the instruction, wherein the recipient is not required to process the data item.

11. The method of claim 1 wherein providing the data item to the recipient includes providing one of an object representing the content, and at least one data structure based on the determined MIME type and corresponding to the content.

12. The method of claim 1 wherein prior to providing the data item to the recipient, the method includes determining at least one of whether the recipient is allowed to receive the data item, and whether the data item is a threat to the electronic device.

13. A method for managing communication protocol data in a communication stack of an electronic device, the method comprising:
providing a MIME type communication layer in a communication stack of an electronic device, wherein the communication stack comprises a plurality of communication layers and is operatively coupled to a network interface for receiving and sending data of a specified MIME type over a network;
receiving by the MIME type communication layer a data item for association with an element of a specified MIME type, and a communication endpoint identifier associated with a sender of the data item;
determining by the MIME type communication layer whether the data item is compatible with the element of the specified MIME type;
generating by the MIME type communication layer content including the data item, the content compatible with the specified MIME type when the data item is determined to be compatible with the element of the specified MIME type; and
providing the content and the communication endpoint identifier to an underlying communication layer of the communication stack.

14. The method of claim 13 wherein determining whether the data item is compatible with the element includes using a schema that defines a format specification corresponding to the specified MIME type.

15. The method of claim 13 wherein generating content including the data item includes using a schema that defines a format specification corresponding to the specified MIME type and constructing a structured data model representing the content.

16. The method of claim 13 wherein providing the content and the communication endpoint identifier to the underlying communication layer of the communication stack includes:
creating a protocol frame compatible with a frame format associated with the MIME type communication layer;
including the content and the communciation endpoint identifier in the protocol frame; and
passing the protocol frame to the underlying communication layer of the communication stack.

17. The method of claim 16 including providing a MIME type indicator in the protocol frame along with the content and the communciation endpoint identifier.

18. The method of claim 13 wherein prior to providing the content and the communication endpoint identifier to the underlying communication layer, the method includes determining whether the sender is allowed to send the data item.

19. A system for managing communication protocol data received by and sent from an electronic device, the system comprising:
means for receiving a protocol frame that includes content in a payload, and an endpoint identifier associated with a recipient of the content;
means for determining by the MIME type communication layer a MIME type associated with the content;
means for identifying an element of the determined MIME type by parsing the content of the protocol frame based on the determined MIME type;
means for determining a data item in the content corresponding to the identifed element of the determined MIME type; and
means for providing the data item to the recipient asociated with the endpoint identifier. wherein the recipient receives the data item without parsing the content of the protocol frame.

20. A system for managing communication protocol data received by and sent from an electronic device, the system comprising:
a network interface card configured for receiving and sending data over a network; and
a communication stack component coupled to the network interface card, wherein the communication stack component includes:
a physical communication layer coupled to the network interface card; and
a MIME type communication layer configured for receiving via the physical communication layer a protocol frame that includes content in a payload, and an endpoint identifier associated with a recipient of the content, wherein the MIME type communication layer includes:
a content router component configured for determining a MIME type associated with the content of the protocol frame; and
a content controller component associated with the determined MIME type, wherein when the content router determines the MIME type associated with the content of the protocol frame, the content router routes the content to the content controller component associated with the determined MIME type, the content controller component configured for identifying an element of the determined MIME type by parsing the content of the protocol frame according to the determined MIME type, for determining a data item in the content corresponding to the identified element of the determined MIME type, and for providing the data item to the recipient asociated with the endpoint identifier, wherein the recipient receives the data item without parsing the content of the protocol frame.

21. The system of claim 20 wherein the MIME type communication layer is configured for dynamically registering a new content controller associated with a new MIME type and for configuring the content router to locate and route content to the new content controller.

22. The system of claim 20 wherein the content router is configured for at least one of analyzing a MIME type indicator included in the protocol frame, and using the content controller component to analyze at least a portion of the content to determine at least one of a signature, a type indicator, and a characteristic corresponding to the determined MIME type.

23. The system of claim 20 wherein the content controller includes a content parser component compatible with the determined MIME type and configured for parsing the content of the protocol frame according to a format of the determined MIME type.

24. The system of claim 20 wherein the content controller includes a content parser component, a modeler component, and a validator component, wherein the parser component is configured for identifying a plurality of elements in the content based on a format of the determined MIME type, wherein the plurality of identified elements are associated with a plurality of data items, the modeler component is configured for constructing a structured data model of the parsed content using the plurality of identified elements, and the validator component is configured for validating the plurality of data items according to the format of the determined MIME type.

25. The system of claim 24 wherein the content parser component is configured for one of receiving a stream of data corresponding to the content to be parsed and dynamically parsing the stream of data, and receiving the content as a whole and parsing the content as a whole.

26. The system of claim 24 wherein the modeler component is configured for storing the structured data model.

27. The system of claim 20 wherein the content controller component includes a content output interface configured for sending an indication to the recipient, wherein the indication includes an identifier associated with at least one of the content and the data item.

28. The system of claim 27 wherein the content output interface is configured for at least one of calling an executable routine associated with the endpoint identifier and receiving a callback from the executable routine to retrieve the data item, for receiving a query from an executable routine associated with the endpoint identifier and sending the indication to the recipient in response to the query, for sending a notification including the indication to the recipient based on a subscription to the endpoint identifier, and for placing the indication in a message queue associated with the endpoint identifier.

29. The system of claim 20 wherein the content controller component includes a content output interface configured for providing one of an object representing the content, and at least one data structure based on the determined MIME type and corresponding to the content.

30. The system of claim 20 wherein the content controller component includes a set of common functions associated with a MIME type, wherein the set of common functions include at least one of a display function, a storage function, an edit function, and a delete function, and wherein the content controller component is configured for receiving from the recipient an instruction to apply at least one common function of the set of common functions against the data item, and for applying the at least one common function against the data item pursuant to the instruction, wherein the recipient is not required to process the data item.

31. The system of claim 20 wherein the content controller component includes a content output interface configured for determining at least one of whether the recipient is allowed to receive the data item, and whether the data item is a threat to the electronic device.

32. The system of claim 20 wherein the communication stack component includes an application communication layer, wherein the MIME type communication layer is between the application communication layer and the physical communication layer, and wherein the content controller component is configured for receiving via the application communication layer a second data item and a communication endpoint identifier associated with a sender of the second data item, for determining whether the second data item is compatible with an element of the determined MIME type associated with the content controller component, for generating content including the second data item, the content compatible with the determined MIME type when the second data item is determined to be compatible with the element of the determined MIME type, and for providing the content and the communication endpoint identifier associated with the sender of the second data item to the physical communication layer of the communication stack.

33. A computer readable medium containing a computer program, executable by a machine, for managing communication protocol data in a communication stack of an electronic device, the computer program comprising executable instructions for:
receiving by a MIME type communication layer in a communication stack of an electronic device a protocol frame that includes content in a payload, and an endpoint identifier associated with a recipient of the content;
determining by the MIME type communication layer a MIME type associated with the content;
identifying by the MIME type communication layer an element of the determined MIME type by parsing the content of the protocol frame based on the determined MIME type;
determining by the MIME type communication layer a data item in the content corresponding to the identified element of the determined MIME type; and
providing by the MIME type communication layer the data item to the recipient asociated with the endpoint identifier, wherein the recipient receives the data item without parsing the content of the protocol frame.

34. A computer readable medium containing a computer program, executable by a machine, for managing communication protocol data in a communication stack of an electronic device, the computer program comprising executable instructions for:
receiving by a MIME type communication layer in a communication stack of an electronic device a data item for association with an element of a specified MIME type, and a communication endpoint identifier associated with a sender of the data item;
determining by the MIME type communication layer whether the data item is compatible with the element of the specified MIME type;
generating by the MIME type communication layer content including the data item, the content compatible with the specified MIME type when the data item is determined to be compatible with the element of the specified MIME type; and
providing the content and the communication endpoint identifier to an underlying communication layer of the communication stack.
